(19) United States
(12) Patent Application Publication
(10) Pub. No.: US 2023/0222426 A1
(43) Pub. Date: Jul. 13, 2023

(54) Evaluating Effectiveness of Real-Time Messages

(71) Applicant: International Business Machines Corporation, Armonk, NY (US)

(72) Inventors: Mary Diane Swift, Rochester, NY (US); Irene Lizeth Manotas Gutiérrez, White Plains, NY (US); Qi Li, Beijing (CN); Jonathan D. Dunne, Dungarvan (IE)

(21) Appl. No.: 17/647,487

(22) Filed: Jan. 10, 2022

(51) Int. Cl. G06Q 10/06; G06Q 50/00

(52) U.S. Cl. CPC G06Q 10/06393; G06Q 50/01

(57) ABSTRACT

Dynamically evaluating effectiveness of real-time messages is provided. A scalable signal reconstruction analysis of real-time message content in a question-and-answer format posted in a social network is performed. A message effectiveness evaluator model is generated based on the scalable signal reconstruction analysis of the real-time message content in the question-and-answer format. An effectiveness score corresponding to the real-time message content in the question-and-answer format is generated using the message effectiveness evaluator model.

### BACKGROUND

### 1. Field

The disclosure relates generally to real-time messaging and more specifically to dynamically evaluating effectiveness of real-time message content in a question-and-answer format by generating an effectiveness score corresponding to the real-time message content using a message effectiveness evaluator model.

### 2. Description of the Related Art

Real-time messaging refers to the distribution and delivery of messages, which are consumed or read synchronously. Real-time messaging on the Web typically involves a social network in which data is streamed or pushed to users. Real-time messaging can be used in, for example, chat programs, instant messaging programs, social media platforms, collaboration tools, customer support systems, online multiplayer gaming systems, and the like. In other words, real-time messaging provides instantaneous and scalable communications (e.g., text-based conversations) between all participating users. Real-time messages are typically packaged using standard formats, such as, for example, JavaScript® Object Notation. JavaScript is a registered trademark of Oracle America, Inc., Redwood Shores, Calif.

### SUMMARY

According to one illustrative embodiment, a computer-implemented method for dynamically evaluating effectiveness of real-time messages is provided. A computer performs a scalable signal reconstruction analysis of real-time message content in a question-and-answer format posted in a social network. The computer generates a message effectiveness evaluator model based on the scalable signal reconstruction analysis of the real-time message content in the question-and-answer format. The computer generates an effectiveness score corresponding to the real-time message content in the question-and-answer format using the message effectiveness evaluator model. According to other illustrative embodiments, a computer system and computer program product for dynamically evaluating effectiveness of real-time messages are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a real-time message analysis process in accordance with an illustrative embodiment;

FIG. 4 is a diagram illustrating an example of a message effectiveness evaluator model generation process in accordance with an illustrative embodiment;

FIG. 5 is a diagram illustrating an example of a real-time message effectiveness evaluation process in accordance with an illustrative embodiment;

FIG. 6 is a flowchart illustrating a process for generating a message effectiveness evaluator model in accordance with an illustrative embodiment; and

FIGS. 7A-7B are a flowchart illustrating a process for dynamically evaluating effectiveness of real-time messages in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

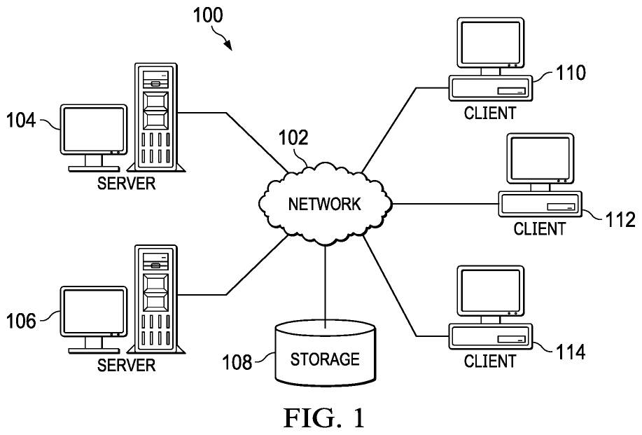

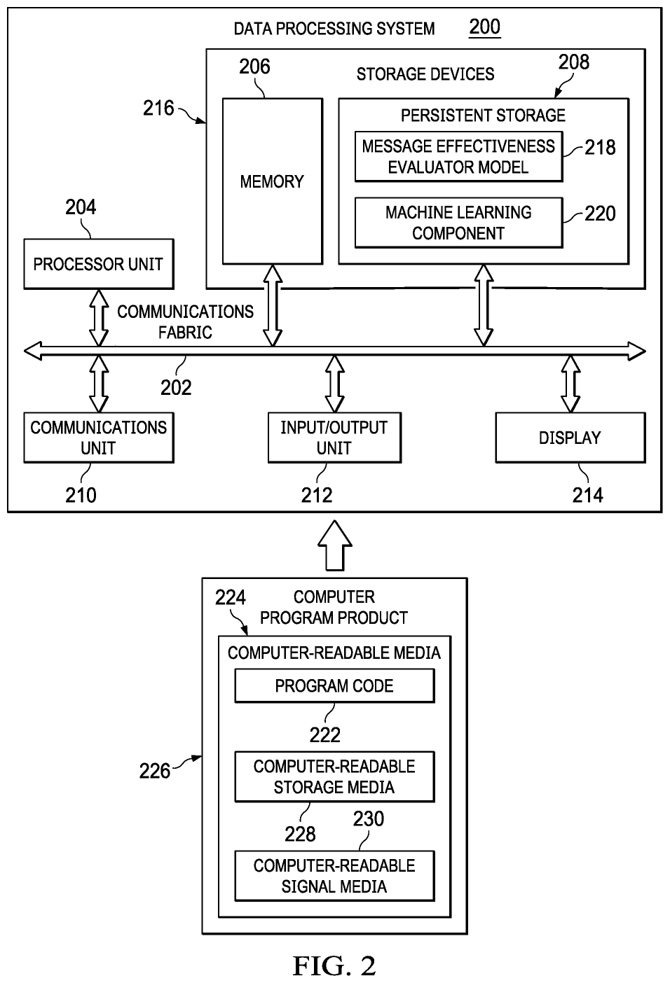

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent a cluster of servers in one or more data centers. Alternatively, server 104 and server 106 may each represent multiple computing nodes in one or more cloud environments.

In addition, server 104 and server 106 may provide real-time messaging services to client device users via a plurality of social networks. Further, server 104 and server 106 can perform dynamic evaluation of the effectiveness of real-time messages in a question-and-answer format. For example, server 104 and server 106 generate a message effectiveness evaluator model that operates in real-time to evaluate real-time message effectiveness (e.g., measures the effectiveness of an answer to a posted question regarding a problem that a user is experiencing). Server 104 and server 106 analyze real-time message content posted in a social network using scalable signal reconstruction, and evaluate the effectiveness of the analyzed real-time messages using the generated message effectiveness evaluator model to discriminate between effective messages and ineffective messages to increase user experience and overall message quality in the social networks. Server 104 and server 106 can apply the message effectiveness evaluator model to any type of real-time message content, such as, for example, posted questions and provided answers regarding any topic during real-time messaging in any social network.

Client 110, client 112, and client 114 also connect to network 102. Clients 110, 112, and 114 are client devices of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, gaming devices, and the like, with wire or wireless communication links to network 102. Users of clients 110, 112, and 114 may utilize clients 110, 112, and 114 to access and utilize the real-time messaging services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for a plurality of client devices, identifiers for a plurality of client device users, user profiles corresponding to the plurality of client device users, historical question-and-answer text regarding a plurality of different problems and topics, message effectiveness evaluator models, machine learning models, and the like. Furthermore, storage 108 may store other types of data, such as authentication or credential data that may include usernames, passwords, and the like associated with, for example, client device users and system administrators.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 104 in FIG. 1, in which computer-readable program code or instructions implementing the dynamic real-time message effectiveness evaluation processes of illustrative embodiments may be located. In this example, data processing system 200 includes communications fabric 202, which provides communications between processor unit 204, memory 206, persistent storage 208, communications unit 210, input/output unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory, or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores message effectiveness evaluation model 218. However, it should be noted that even though message effectiveness evaluation model 218 is illustrated as residing in persistent storage 208, in an alternative illustrative embodiment, message effectiveness evaluation model 218 may be a separate component of data processing system 200. For example, message effectiveness evaluation model 218 may be a hardware component coupled to communication fabric 202 or a combination of hardware and software components. In another alternative illustrative embodiment, a first set of components of message effectiveness evaluation model 218 may be located in data processing system 200 and a second set of components of message effectiveness evaluation model 218 may be located in a second data processing system, such as, for example, server 106 in FIG. 1.

Message effectiveness evaluation model 218 controls the process of dynamically evaluating the effectiveness of real-time messages in a question-and-answer format posted on a social network. Message effectiveness evaluation model 218 evaluates (e.g., generates an effectiveness score) for each respective component (e.g., a term, sentence, paragraph, or the like) of an answer to a posted question and identifies corresponding summary features (e.g., topics, tags, labels, or the like) of the answer components to assess the effectiveness and relevancy of the answer in its entirety and the effectiveness and relevancy of each respective component part of the answer in order for a user to identify possible issues (e.g., inaccuracies, errors, incompleteness, and the like) with the answer. In other words, message effectiveness evaluation model 218 not only provides an overall assessment of answer effectiveness or quality regarding the posted question, but also provides assessment of each respective component of an answer.

In this example, message effectiveness evaluation model 218 includes machine learning component 220. However, in an alternative illustrative embodiment, machine learning component 220 can be a separate or stand-alone component of data processing system 200. Machine learning component 220 fine-tunes, adjusts, or customizes message effectiveness evaluation model 218 over time. For example, machine learning component 220 involves inputting data to the process and allowing the process to adjust and improve the predictive accuracy and functionality of message effectiveness evaluation model 218 over time, thereby increasing the performance of data processing system 200, itself.

Machine learning component 220 can learn without being explicitly programmed to do so. Machine learning component 220 can learn based on training data (e.g., historical question-and-answer text regarding a plurality of different problems and topics involving a plurality of different users), which are input into machine learning component 220. Machine learning component 220 can learn using various types of machine learning algorithms. The various types of machine learning algorithms may include at least one of supervised learning, semi-supervised learning, unsupervised learning, reinforcement learning, feature learning, sparse dictionary learning, anomaly detection, association rules, or other types of learning algorithms. Examples of machine learning models include an artificial neural network, a decision tree, a support vector machine, a Bayesian network, a genetic algorithm, and other types of models.

Machine learning component 220 can customize message effectiveness evaluation model 218 on a per social network and temporal basis. In other words, machine learning component 220 can customize message effectiveness evaluation model 218 on a specific social network, such as, for example, a technical social network, over a relative measurement of time. Thus, message effectiveness evaluation model 218 is capable of evaluating the effectiveness of real-time messages in a question-and-answer format regarding a particular problem or topic posted by a plurality of users on a particular social network.

As a result, data processing system 200 operates as a special purpose computer system in which message effectiveness evaluation model 218 in data processing system 200 enables automatic evaluation of an answer's effectiveness in resolving a problem corresponding to a posted question by a user to increase user experience and user understanding of the problem's solution. In particular, message effectiveness evaluation model 218 transforms data processing system 200 into a special purpose computer system as compared to currently available general computer systems that do not have message effectiveness evaluation model 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 222 is located in a functional form on computer-readable media 224 that is selectively removable and may be loaded onto or transferred to data processing system 200 for running by processor unit 204. Program code 222 and computer-readable media 224 form computer program product 226. In one example, computer-readable media 224 may be computer-readable storage media 228 or computer-readable signal media 230.

In these illustrative examples, computer-readable storage media 228 is a physical or tangible storage device used to store program code 222 rather than a medium that propagates or transmits program code 222. Computer-readable storage media 228 may include, for example, an optical or magnetic disc that is inserted or placed into a drive or other device that is part of persistent storage 208 for transfer onto a storage device, such as a hard drive, that is part of persistent storage 208. Computer-readable storage media 228 also may take the form of a persistent storage, such as a hard drive, a thumb drive, or a flash memory that is connected to data processing system 200.

Alternatively, program code 222 may be transferred to data processing system 200 using computer-readable signal media 230. Computer-readable signal media 230 may be, for example, a propagated data signal containing program code 222. For example, computer-readable signal media 230 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 224” can be singular or plural. For example, program code 222 can be located in computer-readable media 224 in the form of a single storage device or system. In another example, program code 222 can be located in computer-readable media 224 that is distributed in multiple data processing systems. In other words, some instructions in program code 222 can be located in one data processing system while other instructions in program code 222 can be located in one or more other data processing systems. For example, a portion of program code 222 can be located in computer-readable media 224 in a server computer while another portion of program code 222 can be located in computer-readable media 224 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 222.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

In a social network, such as, for example, an online technical social network or forum, every provided answer to a posted question regarding a technical problem experienced by a user is potentially helpful for solving that particular technical problem. However, sometimes provided answers to problems are ineffective (e.g., not helpful, incorrect, inaccurate, or not relevant) and can be misleading. Further, a user can copy an ineffective answer from one technical social network and forward that ineffective answer onto another social network or forum, propagating ineffective information.

Generally, question posers and answer readers have to spend time evaluating the effectiveness of answers. For a specific technical topic, such as, for example, software development, a user answering a posted question regarding a problem with software may need to do configuration changes or even code testing of the software to verify that the user's solution to the problem is correct. However, this may consume a lot of the user's time and effort. Furthermore, this type of scenario is not limited to technical social networks that use question-and-answer formats, but is common to any type of social network that provides knowledge sharing or the like.

Some social networks utilize a voting mechanism, such as, for example, up vote, down vote, thumbs up, thumbs down, smiley face, frowny face, and the like, to rank or rate the effectiveness of an answer to a posted question regarding a problem. Although these mechanisms can be useful for answers that do not have any type of peer review to ensure that these answers are correct, an additional mechanism is needed. Illustrative embodiments utilize a message effectiveness evaluator model to automatically analyze answers to questions regarding problems posted on social networks. The message effectiveness evaluator model enables real-time discrimination between effective answer messages, which may include follow up comments, and ineffective answer messages. The message effectiveness evaluator model is also capable of automatically tracking and removing ineffective messages that were copied and forwarded onto other social networks to increase answer quality as a whole on social networks and improve user experience.

Illustrative embodiments perform a scalable signal reconstruction analysis of the real-time message content posted on the social networks. Illustrative embodiments utilize the scalable signal reconstruction analysis to solve a series of equations to determine pairwise similarity between user expertise and question-and-answer text. Illustrative embodiments convert user profile data corresponding to a particular user providing an answer to a posted question into a series of algebraic expressions reducing the user profile data to core terms to identify clusters of user expertise, which illustrative embodiments utilize to compute probabilities of the likelihood that these core terms corresponding to the clusters of user expertise will appear in the question-and-answer text.

Illustrative embodiments generate the message effectiveness evaluator model based on the scalable signal reconstruction analysis of the real-time message content. Illustrative embodiments utilize the message effectiveness evaluator model to dynamically evaluate the effectiveness of the real-time message content by generating an effectiveness score for each respective component of the real-time message content. Illustrative embodiments can customize the message effectiveness evaluator model on a per social network and temporal basis using machine learning.

Further, illustrative embodiments can generate a user expertise relevancy score corresponding to the user who provided the answer to the posted question based on a similarity analysis (e.g., cosign similarity, Jaccard index, Manhattan distance, or the like) of the user's profile data, publications, and other user expertise information relevant to the topic of the posted question. A higher user expertise relevancy score contributes to a higher effectiveness score for the answer provided by that particular user.

Furthermore, illustrative embodiments maintain a list of known sources of information (e.g., text corpora, historical answers corresponding to different problems and topics related to previously posted questions, and the like) for validating current answers to posted questions. Moreover, illustrative embodiments can display a message effectiveness score against each known source of information. In addition, illustrative embodiments can update the list of known sources of information with suggested sources that are subject to a configurable minimum effectiveness threshold level. In other words, a suggested source needs a message effectiveness score greater than the configurable minimum effectiveness threshold level for illustrative embodiments to add that suggested source to the list of known sources of information.

Illustrative embodiments also take into account answers to equivalent questions (e.g., same or similar questions) and links to information included in those answers during generation of the message effectiveness evaluator model. Illustrative embodiments using the message effectiveness evaluator model can generate an effectiveness score for each respective component part (e.g., term, sentence, paragraph, and the like) of a given answer to a posted question, as well as a composite effectiveness score for the entire answer. A user can utilize these effectiveness scores to evaluate the effectiveness of each respective component of an answer and only consider those components that have higher effectiveness scores (e.g., greater than a predefined minimum effectiveness score threshold level of 0.50). Alternatively, illustrative embodiments will only display on the social network answers or individual answer components having an effectiveness score greater than the predefined minimum effectiveness score threshold level. In addition, illustrative embodiments can associate identified summary features (e.g., topics, tags, labels, and the like) with answers and display the identified summary features with the effectiveness scores for each respective component of the answer in the social network via a graphical user interface. Illustrative embodiments can also utilize the message effectiveness evaluator model with other systems, such as, for example, a ticketing system, root cause analysis system, or the like, to identify the most effective comments added to a ticket to resolve a particular problem.

Thus, illustrative embodiments provide one or more technical solutions that overcome a technical problem with ineffective or inaccurate solution information regarding encountered problems being posted in real-time on social networks. As a result, these one or more technical solutions provide a technical effect and practical application in the field of real-time network communications.

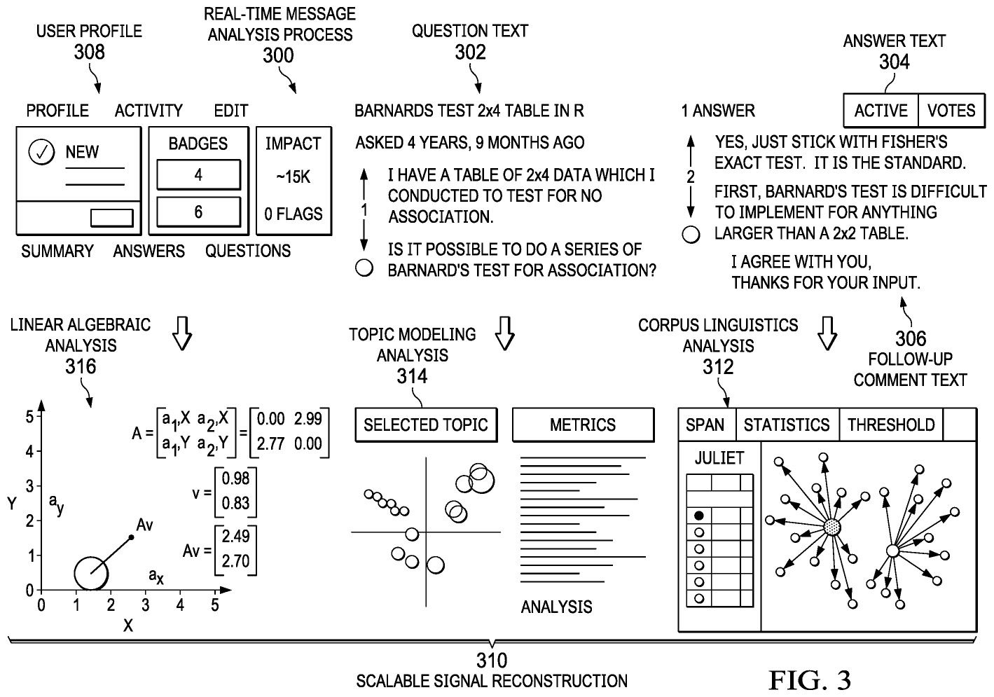

With reference now to FIG. 3, a diagram illustrating an example of a real-time message analysis process is depicted in accordance with an illustrative embodiment. Real-time message analysis process 300 may be implemented in a computer, such as, for example, server 104 in FIG. 1 or data processing system 200 in FIG. 2.

In this example, real-time message analysis process 300 analyzes question text 302, answer text 304, follow up comment text 306, and user profile 308 using scalable signal reconstruction 310. Question text 302 represents a set of question messages regarding an encountered problem or issue posted in real-time by a user on a social network. The real-time messages may be, for example, instant messages, chat room posts, technical forum posts, social media posts, or the like. In addition, it should be noted that the social network includes a plurality of users posting questions and answers to those questions. Answer text 304 represents a set of answer messages, which provides one or more potential solutions to the problem described in the content of question text 302, that is posted in real-time by another user on the social network. Follow up comment text 306 is optionally posted by the user who provided answer text 304 or may be posted by yet another user. Follow up comment text 306 represents a set of additional commentary to clarify or further explain the content of answer text 304. User profile 308 represents a profile corresponding to the user that provided answer text 304. User profile 308 may include, for example, educational degree and major of the user, job title of the user, years of experience of the user, area and level of expertise of the user, social network memberships of the user, history of provided answers by the user to previously posted questions, effectiveness scores corresponding to previously provided answers by the user, and the like.

Scalable signal reconstruction 310 performs pairwise similarity matching between the expertise of the user who provided answer text 304, which is derived from analyzing information contained in user profile 308, and the content of question text 302, which is derived from analyzing the textual content of question text 302, to determine whether any components of answer text 304 have a defined level of credibility and trustworthiness with regard to question text 302. In this example, scalable signal reconstruction 310 includes corpus linguistics analysis 312, topic modeling analysis 314, and linear algebraic analysis 316. Scalable signal reconstruction 310 utilizes corpus linguistics analysis 312 to determine linguistic patterns (e.g., word frequencies, word patterns, word collocations, user writing style, and the like) within question text 302, answer text 304, and follow up comment text 306. Corpus linguistics is a computer-aided analysis of natural language as expressed in a body of text. Scalable signal reconstruction 310 utilizes topic modeling analysis 314 to determine a set of topics being discussed in question text 302, answer text 304, and follow up comment text 306. Topic modeling is a type of statistical analysis using text mining to discover topics that occur in a body of text (e.g., grouping words that correspond to a particular topic). Scalable signal reconstruction 310 utilizes linear algebraic analysis 316 to represent the data, which is contained in question text 302, answer text 304, follow up comment text 306, and user profile 308, in the form of linear equations. These linear equations are in turn represented in the form of matrices and vectors (e.g., Eigenvectors) to reduce question text 302, answer text 304, follow up comment text 306, and user profile 308 to core terms in X, Y coordinates to perform the pairwise similarity matching.

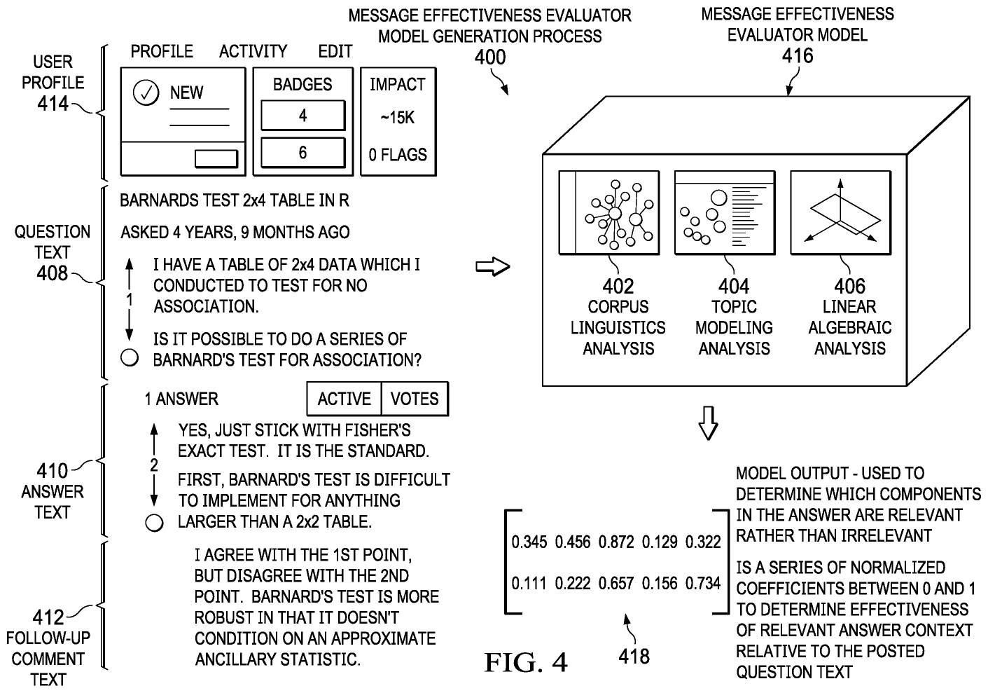

With reference now to FIG. 4, a diagram illustrating an example of a message effectiveness evaluator model generation process is depicted in accordance with an illustrative embodiment. Message effectiveness evaluator model generation process 400 may be implemented in a computer, such as, for example, server 104 in FIG. 1 or data processing system 200 in FIG. 2.

In this example, message effectiveness evaluator model generation process 400 utilizes corpus linguistic analysis 402, topic modeling analysis 404, and linear algebraic analysis 406 of question text 408, answer text 410, follow up comment text 412, and user profile 414 to generate message effectiveness evaluator model 416. Corpus linguistic analysis 402, topic modeling analysis 404, and linear algebraic analysis 406 may be, for example, corpus linguistics analysis 312, topic modeling analysis 314, and linear algebraic analysis 316 in FIG. 3. Question text 408, answer text 410, follow up comment text 412, and user profile 414 may be, for example, question text 302, answer text 304, follow up comment text 306, and user profile 308 in FIG. 3. Message effectiveness evaluator model 416 may be, for example, message effectiveness evaluator model 218 in FIG. 2.

In this example, message effectiveness evaluator model 416 generates model output 418 based on analysis of the textual content in question text 408, answer text 410, follow up comment text 412, and user profile 414. Message effectiveness evaluator model 416 utilizes model output 418 to determine which components of answer text 410 are relevant rather than irrelevant. Further, model output 418 is a series of normalized coefficients between 0 and 1 that message effectiveness evaluator model 416 utilizes to determine the effectiveness of relevant components of answer text 410 relative to question text 408. Furthermore, message effectiveness evaluator model 416 can utilize the normalized coefficients as highlighting coefficients to highlight respective components of answer text 410 based on their corresponding coefficient value. Message effectiveness evaluator model 416 can derive the coefficients from, for example, topic likelihood, term frequency, bigram count, trigram count, tone analysis, user profile analysis, and the like. Moreover, it should be noted that a machine learning component, such as, for example, machine learning component 220 in FIG. 2, can automatically adjust and customize message effectiveness evaluator model 416 on a social network basis over time.

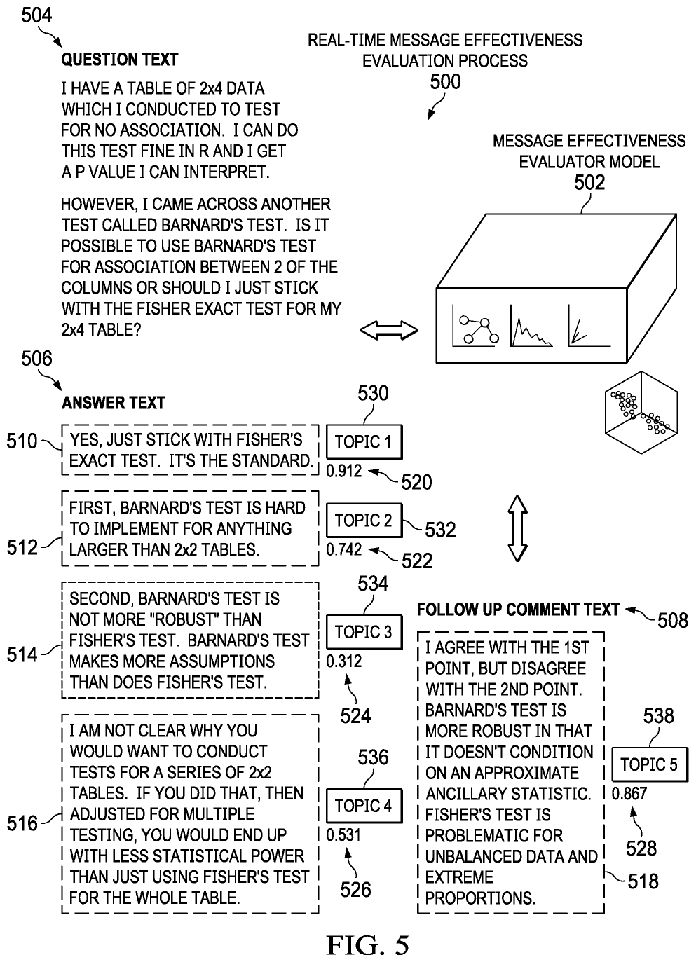

With reference now to FIG. 5, a diagram illustrating an example of a real-time message effectiveness evaluation process is depicted in accordance with an illustrative embodiment. Real-time message effectiveness evaluation process 500 may be implemented in a computer, such as, for example, server 104 in FIG. 1 or data processing system 200 in FIG. 2.

In this example, real-time message effectiveness evaluation process 500 is implemented in message effectiveness evaluation model 502, such as, for example, message effectiveness evaluation model 416 in FIG. 4. Real-time message effectiveness evaluation process 500 applies message effectiveness evaluation model 502 to question text 504, answer text 506, and follow up comment text 508, such as, for example, question text 408, answer text 410, and follow up comment text 412 in FIG. 4.

Message effectiveness evaluation model 502 identifies respective components of answer text 506 and follow up comment text 508 as related to the content of question text 504. In addition, message effectiveness evaluation model 502 generates an effectiveness score for each respective component of answer text 506 and follow up comment text 508. Further, message effectiveness evaluation model 502 identifies a summary feature (e.g., topic) for each respective component of answer text 506 and follow up comment text 508. Furthermore, message effectiveness evaluation model 502 highlights (e.g., using various colors) components of answer text 506 and follow up comment text 508 based on their corresponding effectiveness scores.

In this example, message effectiveness evaluation model 502 identifies 4 components of answer text 506 and 1 component of follow up comment text 508 as related to the content of question text 504. The 4 components of answer text 506 include component 510, component 512, component 514, and component 516. Each of component 510 and component 512 comprises a different sentence of answer text 506. Each of component 514 and component 516 comprises a different paragraph of answer text 506. The 1 component of follow up comment text 508 comprises a paragraph as related to answer text 506.

Also in this example, message effectiveness evaluation model 502 generates effectiveness score 520 (e.g., 0.912) for component 510, effectiveness score 522 (e.g., 0.742) for component 512, effectiveness score 524 (e.g., 0.312) for component 514, and effectiveness score 526 (e.g., 0.531) for component 516 of answer text 506. In addition, message effectiveness evaluation model 502 generates effectiveness score 528 (e.g., 0.867) for component 518 of follow up comment text 508.

Further in this example, message effectiveness evaluation model 502 identifies summary feature 530 (e.g., topic 1) for component 510, summary feature 532 (e.g., topic 2) for component 512, summary feature 534 (e.g., topic 3) for component 514, and summary feature 536 (e.g., topic 4) for component 516 of answer text 506. In addition, message effectiveness evaluation model 502 identifies summary feature 538 (e.g., topic 5) for component 518 of follow up comment text 508.

Yet further in this example, message effectiveness evaluation model 502 highlights components 510, 512, and 516 of answer text 506 using, for example, a green color and highlights component 514 using, for example, a red color based on corresponding effectiveness scores of 0.912, 0.742, 0.531, and 0.312, respectively. In addition, message effectiveness evaluation model 502 highlights component 518 of follow up comment text 508 using, for example, a green color based on its corresponding effectiveness score of 0.867. It should be noted that an effectiveness score closer to 1 equals a greater level of effectiveness for an answer component, whereas an effectiveness score closer to 0 equals a lesser level of effectiveness (e.g., a greater level of ineffectiveness) for that answer component as related to question text 504. Message effectiveness evaluation model 502 can display all of this information in the social network to users via a graphical user interface.

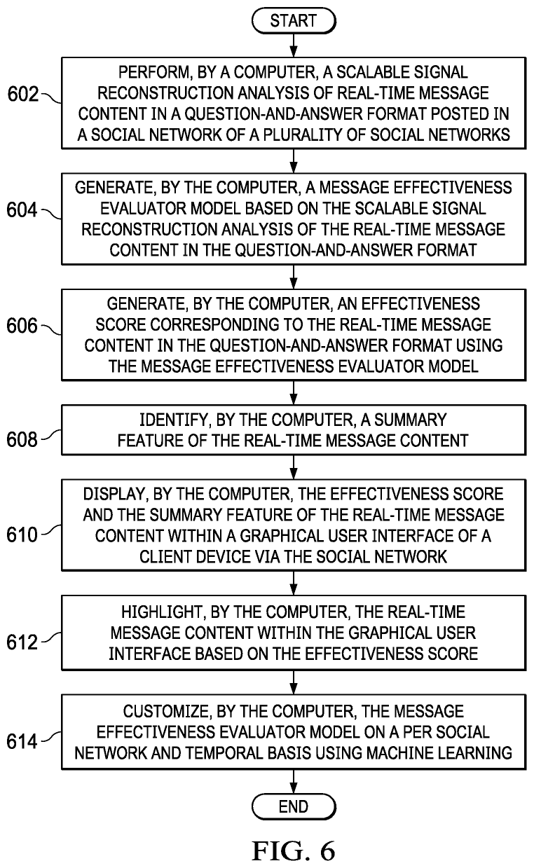

With reference now to FIG. 6, a flowchart illustrating a process for generating a message effectiveness evaluator model is shown in accordance with an illustrative embodiment. The process shown in FIG. 6 may be implemented in a computer, such as, for example, server 104 in FIG. 1 or data processing system 200 in FIG. 2. For example, the process shown in FIG. 6 may be implemented in message effectiveness evaluator model 218 in FIG. 2 or message effectiveness evaluator model 416 in FIG. 4.

The process begins when the computer performs a scalable signal reconstruction analysis of real-time message content in a question-and-answer format posted in a social network of a plurality of social networks (step 602). The computer generates a message effectiveness evaluator model based on the scalable signal reconstruction analysis of the real-time message content in the question-and-answer format (step 604). In addition, the computer generates an effectiveness score corresponding to the real-time message content in the question-and-answer format using the message effectiveness evaluator model (step 606). Further, the computer identifies a summary feature of the real-time message content (step 608).

The computer displays the effectiveness score and the summary feature of the real-time message content within a graphical user interface of a client device via the social network (step 610). The computer also highlights the real-time message content within the graphical user interface based on the effectiveness score (step 612). Moreover, the computer customizes the message effectiveness evaluator model on a per social network and temporal basis using machine learning (step 614). Thereafter, the process terminates.

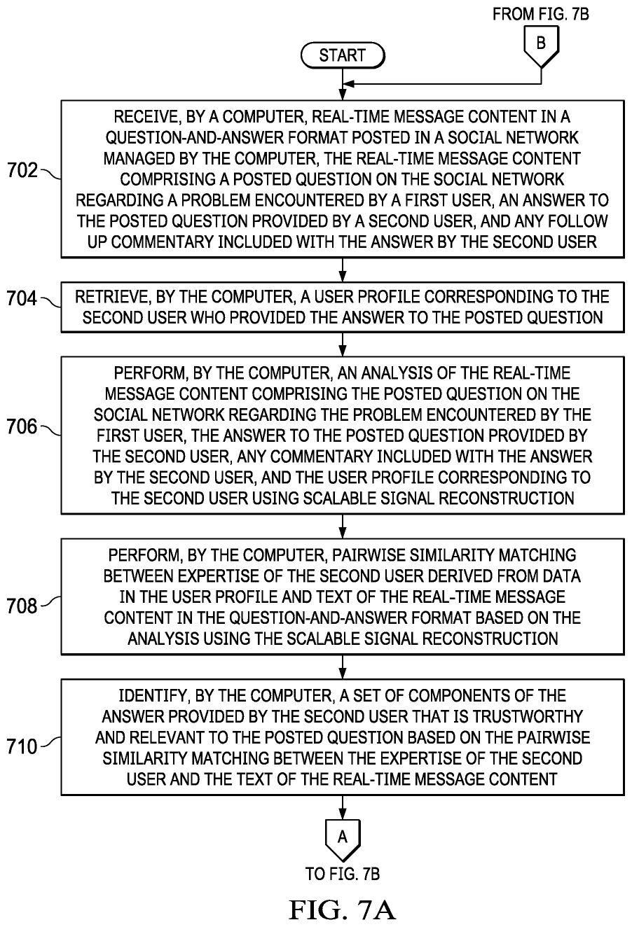

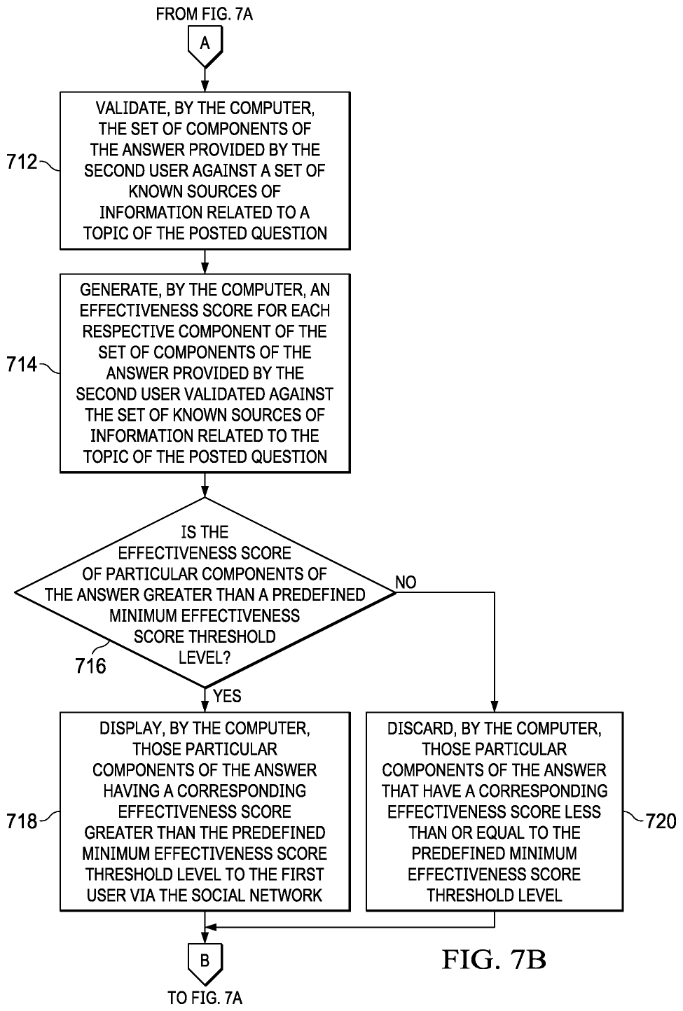

With reference now to FIGS. 7A-7B, a flowchart illustrating a process for dynamically evaluating effectiveness of real-time messages is shown in accordance with an illustrative embodiment. The process shown in FIGS. 7A-7B may be implemented in a computer, such as, for example, server 104 in FIG. 1 or data processing system 200 in FIG. 2. For example, the process shown in FIGS. 7A-7B may be implemented in message effectiveness evaluator model 218 in FIG. 2 or message effectiveness evaluator model 416 in FIG. 4.

The process begins when the computer receives real-time message content in a question-and-answer format posted in a social network managed by the computer (step 702). The real-time message content comprising a posted question on the social network regarding a problem encountered by a first user, an answer to the posted question provided by a second user, and any follow up commentary included with the answer by the second user. The computer retrieves a user profile corresponding to the second user who provided the answer to the posted question (step 704).

The computer performs an analysis of the real-time message content comprising the posted question on the social network regarding the problem encountered by the first user, the answer to the posted question provided by the second user, any commentary included with the answer by the second user, and the user profile corresponding to the second user using scalable signal reconstruction (step 706). Further, the computer performs pairwise similarity matching between expertise of the second user derived from data in the user profile and text of the real-time message content in the question-and-answer format based on the analysis using the scalable signal reconstruction (step 708). The computer identifies a set of components of the answer provided by the second user that is trustworthy and relevant to the posted question based on the pairwise similarity matching between the expertise of the second user and the text of the real-time message content (step 710).

Furthermore, the computer validates the set of components of the answer provided by the second user against a set of known sources of information related to a topic of the posted question (step 712). The computer also validates the entirety of the answer against the set of known sources of information related to the topic of the posted question. The computer generates an effectiveness score for each respective component of the set of components of the answer provided by the second user validated against the set of known sources of information related to the topic of the posted question (step 714).

The computer makes a determination as to whether the effectiveness score of particular components of the answer is greater than a predefined minimum effectiveness score threshold level (step 716). If the computer determines that the effectiveness score of particular components of the answer is greater than the predefined minimum effectiveness score threshold level, yes output of step 716, then the computer displays those particular components of the answer having a corresponding effectiveness score greater than the predefined minimum effectiveness score threshold level to the first user via the social network (step 718). If the computer determines that the effectiveness score of particular components of the answer is not greater than the predefined minimum effectiveness score threshold level, no output of step 716, then the computer discards those particular components of the answer that have a corresponding effectiveness score less than or equal to the predefined minimum effectiveness score threshold level (step 720). Thereafter, the process returns to step 702 where the computer waits to receive more real-time message content.

Thus, illustrative embodiments of the present invention provide a computer-implemented method, computer system, and computer program product for dynamically evaluating effectiveness of real-time message content by generating an effectiveness score corresponding to the real-time message content in a question-and-answer format. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamically evaluating effectiveness of real-time messages, the computer-implemented method comprising:
performing, by a computer, a scalable signal reconstruction analysis of real-time message content in a question-and-answer format posted in a social network;
generating, by the computer, a message effectiveness evaluator model based on the scalable signal reconstruction analysis of the real-time message content in the question-and-answer format; and
generating, by the computer, an effectiveness score corresponding to the real-time message content in the question-and-answer format using the message effectiveness evaluator model.

2. The computer-implemented method of claim 1 further comprising:
identifying, by the computer, a summary feature of the real-time message content.

3. The computer-implemented method of claim 2 further comprising:
displaying, by the computer, the effectiveness score and the summary feature of the real-time message content within a graphical user interface of a client device via the social network.

4. The computer-implemented method of claim 1 further comprising:
highlighting, by the computer, the real-time message content within a graphical user interface of a client device via the social network based on the effectiveness score.

5. The computer-implemented method of claim 1 further comprising:
customizing, by the computer, the message effectiveness evaluator model on a per social network and temporal basis using machine learning.

6. The computer-implemented method of claim 1 further comprising:
receiving, by the computer, the real-time message content in the question-and-answer format posted in the social network that is managed by the computer, the real-time message content comprising a posted question on the social network regarding a problem encountered by a first user, an answer to the posted question provided by a second user, and any follow up commentary included with the answer by the second user;
retrieving, by the computer, a user profile corresponding to the second user who provided the answer to the posted question; and
performing, by the computer, the scalable signal reconstruction analysis of the real-time message content comprising the posted question on the social network regarding the problem encountered by the first user, the answer to the posted question provided by the second user, any commentary included with the answer by the second user, and the user profile corresponding to the second user.

7. The computer-implemented method of claim 6 further comprising:
Performing, by the computer, pairwise similarity matching between expertise of the second user derived from data in the user profile and text of the real-time message content in the question-and-answer format based on the scalable signal reconstruction analysis; and
identifying, by the computer, a set of components of the answer provided by the second user that is trustworthy and relevant to the posted question based on the pairwise similarity matching between the expertise of the second user and the text of the real-time message content.

8. The computer-implemented method of claim 7 further comprising:
validating, by the computer, the set of components of the answer provided by the second user against a set of known sources of information related to a topic of the posted question.

9. The computer-implemented method of claim 8 further comprising:
generating, by the computer, the effectiveness score for each respective component of the set of components of the answer provided by the second user validated against the set of known sources of information related to the topic of the posted question; and
determining, by the computer, whether the effectiveness score of particular components of the answer is greater than a predefined minimum effectiveness score threshold level.

10. The computer-implemented method of claim 9 further comprising:
responsive to the computer determining that the effectiveness score of particular components of the answer is greater than the predefined minimum effectiveness score threshold level, displaying, by the computer, those particular components of the answer having a corresponding effectiveness score greater than the predefined minimum effectiveness score threshold level to the first user via the social network.

11. The computer-implemented method of claim 9 further comprising:
responsive to the computer determining that the effectiveness score of particular components of the answer is not greater than the predefined minimum effectiveness score threshold level, discarding, by the computer, those particular components of the answer that have a corresponding effectiveness score less than or equal to the predefined minimum effectiveness score threshold level.

12. A computer system for dynamically evaluating effectiveness of real-time messages, the computer system comprising:
a bus system;
a storage device connected to the bus system, wherein the storage device stores program instructions; and
a processor connected to the bus system, wherein the processor executes the program instructions to:
perform a scalable signal reconstruction analysis of real-time message content in a question-and-answer format posted in a social network;
generate a message effectiveness evaluator model based on the scalable signal reconstruction analysis of the real-time message content in the question-and-answer format; and
generate an effectiveness score corresponding to the real-time message content in the question-and-answer format using the message effectiveness evaluator model.

13. The computer system of claim 12, wherein the processor further executes the program instructions to:
identify a summary feature of the real-time message content.

14. The computer system of claim 13, wherein the processor further executes the program instructions to:
display the effectiveness score and the summary feature of the real-time message content within a graphical user interface of a client device via the social network.

15. The computer system of claim 12, wherein the processor further executes the program instructions to:
highlight the real-time message content within a graphical user interface of a client device via the social network based on the effectiveness score.

16. A computer program product for dynamically evaluating effectiveness of real-time messages, the computer program product comprising a computer-readable storage medium having program instructions embodied therewith, the program instructions executable by a computer to cause the computer to perform a method of:
performing, by the computer, a scalable signal reconstruction analysis of real-time message content in a question-and-answer format posted in a social network;
generating, by the computer, a message effectiveness evaluator model based on the scalable signal reconstruction analysis of the real-time message content in the question-and-answer format; and
generating, by the computer, an effectiveness score corresponding to the real-time message content in the question-and-answer format using the message effectiveness evaluator model.

17. The computer program product of claim 16 further comprising:
identifying, by the computer, a summary feature of the real-time message content.

18. The computer program product of claim 17 further comprising:
displaying, by the computer, the effectiveness score and the summary feature of the real-time message content within a graphical user interface of a client device via the social network.

19. The computer program product of claim 16 further comprising:
highlighting, by the computer, the real-time message content within a graphical user interface of a client device via the social network based on the effectiveness score.

20. The computer program product of claim 16 further comprising:
customizing, by the computer, the message effectiveness evaluator model on a per social network and temporal basis using machine learning.
